(19) United States
(12) Patent Application Publication
(10) Pub. No.: US 2010/0034444 A1
(43) Pub. Date: Feb. 11, 2010

(54) IMAGE ANALYSIS

(75) Inventors: John Emhoff, Belmont, MA (US); John Healy, Acton, MA (US); Keith Moulton, Amesbury, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Helicos Biosciences Corporation, Cambridge, MA (US)

(21) Appl. No.: 12/187,892

(22) Filed: Aug. 7, 2008

(51) Int. Cl. G06K 9/00

(52) U.S. Cl. 382/129

(57) ABSTRACT

Image processing for certain sequencing technologies requires data processing algorithms that provide fast sequence detection with low error rates. Methods and apparatus for performing image analysis for identifying nucleotide incorporations includes performing an image segmentation procedure on a plurality of data sets to identify sample objects and to create segmented data sets for each of the data sets. Each data set represents a sample image that includes a plurality of pixel locations and intensity data associated with each of the pixel locations. The segmented data sets represent identified sample objects for each one of the sample image data sets. An image registration procedure is performed on the segmented data sets to align the identified sample objects and to create data representative of the aligned identified sample objects. A strand formation procedure is then performed on the data representative of the aligned identified sample objects to identify nucleotide incorporations.

### TECHNICAL FIELD

The invention relates generally to image analysis and more specifically to optical detection and image analysis for single molecule sequencing technologies.

### BACKGROUND INFORMATION

Recent advances in sequencing technology have made possible the rapid, high-throughput and cost-effective sequencing of genomic samples. In particular, next-generation single molecule sequencing technologies have resulted in increased accuracy and a significant increase in information content.

The most promising next-generation sequencing technologies are based upon sequencing-by-synthesis, which utilizes the natural ability of a polymerase enzyme to incorporate a nucleotide into a primer strand in a template-dependent manner. Single molecule sequencing-by-synthesis technologies provide the additional benefit of allowing detection of single nucleotide incorporation in an individual surface-bound duplex.

One of the challenges for all next-generation sequencing technologies is to find data processing algorithms that allow improved sequence detection and reduced error rate. The present invention provides methods for improving the processing and acquisition of sequencing data.

### SUMMARY OF THE INVENTION

Single molecule sequencing technologies take advantage of the fact that individual nucleic acid duplexes bound to a surface are individually monitored through the sequencing process. In a generalized procedure, either a polymerase, a primer molecule, or a template molecule is bound to a surface, such as glass or fused silica. The specific type of surface employed can vary, but typically should be selected to be compatible with the type of label used. A template to be sequenced is hybridized to the primer via complementary base pairing forming a nucleic acid duplex. The attached duplex is then exposed to optically-labeled nucleotides that hybridize to the next available nucleotide in the template (available meaning just 3′ of the primer terminus) and a polymerizing enzyme capable of incorporating the labeled nucleotide into the primer. Each individual duplex is put through a number of cycles of labeled nucleotide addition in which a nucleotide is added to the primer by enzymatic addition in a template-dependent manner and then is optically resolved using a light microscope. For example, if the optically-detectable label is a fluorescent label, then illumination at the appropriate wavelength is used to stimulate fluorescence of the label. Upon completion, a series of base additions to each strand will have been recorded and stored in a computer-readable medium. The next step is to form, or reconstruct, strands from the obtained sequencing data.

Strand formation is a computational procedure that is performed as a part of the image analysis pipeline of single molecule sequencing. In this procedure, observed incorporations of nucleotides for individual duplex molecules on a frame-by-frame basis are combined to produce DNA reads (strands). Described herein is a fast strand formation process with a low error-rate. This process encompasses three main elements that contribute to its overall superiority. The first element improves the throughput of the overall process by implementing an image segmentation procedure to identify sample objects. The second element also improves the throughput of the overall process by implementing an image registration procedure to align a plurality of images in a stack utilizing the segmented image data. The final element in the algorithm produces strands from the aligned sample objects in the stack of sample images.

In one aspect according to the invention, an image analysis method for identifying nucleotide incorporations includes performing an image segmentation procedure on a plurality of data sets to identify sample objects and to create segmented data sets for each of the data sets. Each data set represents a sample image that includes a plurality of pixel locations and intensity data associated with each of the pixel locations. The segmented data sets represent identified sample objects for each one of the sample image data sets. An image registration procedure is performed on the segmented data sets to align the identified sample objects and to create data representative of the aligned identified sample objects. A strand formation procedure is then performed on the data representative of the aligned identified sample objects to identify nucleotide incorporations.

In various embodiments, the image segmentation procedure may include generating foreground masks of the plurality of sample images using an edge detection procedure such as the Sobel operator to identify the edges of sample objects. The image segmentation procedure may also include performing a smoothing function on the plurality of sample images to reduce noise prior to performing edge detection.

In additional embodiments, the image registration procedure may include comparing the sample pixel intensity of each pixel associated with a sample object to the sample pixel intensity of each adjacent pixel and to the mean intensity of the sample image to identify peak pixel coordinates. The peak pixel coordinates can then be compared to a template images to determine an image offset for each of the plurality of sample images.

In a further aspect, the strand formation procedure includes aligning a plurality of foreground masks for each sample image representation and then summing the plurality of foreground masks generating a master image. The master image is then used to identify candidate strand locations from which nucleotide incorporation data can be extracted.

In additional embodiments, the strand formation procedure may include aligning a plurality of foreground masks, wherein the foreground pixels include only those pixels attributed to peaks during registration. The plurality of foreground masks is then summed to create a master image. The master image is then used to identify candidate strand locations from which nucleotide incorporation data can be extracted.

In various embodiments, the strand formation procedure may include calculation of distances between peaks found during registration and candidate strand centers found in the master image. Thresholds on these distances may be used as additional criteria for inclusion of a nucleotide incorporation into a strand. These criteria may be used in combination with criteria enforced on the plurality of foreground masks generated during segmentation.

In a further aspect of strand formation, candidate strands may be excluded from the final output of the process based on relative properties of their neighborhood within the master image. This exclusion process may be applied with respect to either the master image derived from the plurality of foreground masks generated during segmentation, or the master image derived from the plurality of foreground masks generated from the peaks found during registration.

In another embodiment according to the invention, an image processing apparatus for use in a single-molecule detection system includes an image capture subsystem for receiving optical information from a plurality of nucleic acid sequences adhered to a surface and for generating a first set of data representative of the optical information. A first software code processes the first set of data to create a second set of data representative of a two-dimensional field pattern that includes a plurality of pixels and intensity data associated with each of the plurality of pixels. A second software code processes at least one of the first or second sets of data creating a third set of data representative of a replacement two-dimensional field pattern that includes a plurality of objects, each of at least some of the objects being associated with a single molecule of one of the nucleic acid sequences. A third software code processes the third set of data to determine peak pixel locations and aligns a plurality of replacement two-dimensional fields in a stack. The third software code creates a forth set of data representative of the aligned stack of the replacement two-dimensional fields, each of at least some of the aligned stacks being associated with a single molecule of one of the nucleic acid sequences. A forth software code processes the aligned stacks to identify candidate strand locations and evaluates the candidate strand locations to identify nucleotide incorporations.

### BRIEF DESCRIPTION OF THE DRAWINGS

For a fuller understanding of the nature and operation of various embodiments according to the present invention, reference is made to the following description taken in conjunction with the accompanying drawing figures which are not necessarily to scale and wherein like reference characters denote corresponding or related parts throughout the several views.

FIG. 1 is a representation of an image analysis apparatus in accordance with an embodiment of the invention.

FIG. 2 is a flowchart depicting a method for image analysis in accordance with an embodiment of the invention.

FIG. 3 is a flowchart depicting a method for performing image segmentation in accordance with an embodiment of the invention.

FIG. 4 is a flowchart depicting a method for performing image registration in accordance with an embodiment of the invention.

FIGS. 5A and 5B depict a foreground mask being overlaid onto a sample image representation.

FIG. 6 is a representation of a foreground mask overlaid onto a sample image representation.

FIG. 7 depicts an example of a Δx offset histogram for one sample image showing a Δx offset of −0.1 occurring most frequently.

FIG. 8 is a flowchart depicting a method for performing strand formation in accordance with an embodiment of the invention.

FIG. 9 depicts a plurality of the foreground masks stacked on top of each other taking into account their offset (Δx).

FIG. 10 depicts a master image created by summing a plurality of foreground masks.

FIG. 11 depicts the master image of FIG. 10 with small regions being analyzed for uniformity.

### DESCRIPTION

Single molecule sequencing enables the simultaneous sequencing of large numbers of strands of single DNA or RNA molecules by using a method of sequencing-by-synthesis in which labeled DNA bases are sequentially added to the nucleic acid templates captured on a flow cell. Within the flow cell, billions of single molecules of sample DNA are captured on an application-specific surface. These captured strands serve as templates for the sequencing-by-synthesis process.

Two different strategies for sequencing-by-synthesis are under development: single signal and multi-signal. In the first case all four nucleotides are similarly labeled and a detection system is employed which optimally sees only a single output signal. A single signal process requires that the four nucleotides are passed through the system sequentially and imaging occurs after each base addition cycle. In the later case all four nucleotides are differentially labeled and a detection system is employed which uniquely discriminates between each of the four signals. A multi-signal process permits all four nucleotides to be passed through the system simultaneously however imaging occurs in a way that all four signals are uniquely registered. The image analysis and strand formation process described herein is independent of the methodology used to perform the sequencing-by-synthesis process.

Before commencing with the sequencing-by-synthesis process a series of pictures may be taken to locate and define sites of interest referred to as template pictures. These pictures may arise from labels on the primer, the template or even surface bound polymerase molecules. The labels may be permanently attached or have a mechanism for inactivating the label, e.g. a labile bond. The label may have a unique signature different from any of the labeled nucleotides or be the same as one or more of the labeled nucleotides. When the template label is unique and permanently attached multiple template pictures may be taken throughout the sequencing-by-synthesis process to assist in registration alignment. When the label is in common with the nucleotides a single template picture is taken at the beginning of the process and the label is then inactivated or removed.

In one implementation of a single signal process, polymerase and one fluorescently labeled nucleotide (A, G, C, & T/U's) are added. The polymerase catalyzes the sequence-specific incorporation of fluorescent nucleotides into nascent complementary strands on a fraction of all the surface bound templates: only those strands in which the template encodes for the base added during that specific cycle (A:T/U or G:C). It typically is desirable to use nucleotide analogs that add only a single base in a given cycle, e.g. a reversible terminator analog. After a wash step that removes all free nucleotides the incorporated nucleotides are imaged. The fluorescent group is removed in a highly efficient cleavage process, leaving behind the incorporated nucleotide. If a reversible terminator analog is used, the blocking group is removed either simultaneously or sequentially with the fluorophore in a highly efficient cleavage process, leaving behind the incorporated nucleotide. The process continues through each of the other three bases. Multiple four-base cycles result in complementary strands typically greater than 25 bases in length synthesized on billions of templates—typically providing a greater than 25-base read from each of those individual templates.

In one possible multi-signal process, polymerase and four fluorescently distinct labeled nucleotides (A, G, C, & T/U's) are added. The polymerase catalyzes the sequence-specific incorporation of fluorescent nucleotides into nascent complementary strands on all the surface bound templates. Most of the primers add one of the four bases during any given cycle since all four bases are in a single mix. It generally is desirable to use nucleotide analogs that add only a single base in a given cycle, e.g. a reversible terminator analog. After a wash step that removes all free nucleotides the incorporated nucleotides are imaged using four distinct imaging parameters to discern the labels. The fluorescent group is removed in a highly efficient cleavage process, leaving behind the incorporated nucleotide. If a reversible terminator analog is used, the blocking group is removed either simultaneously or sequentially with the fluorophore in a highly efficient cleavage process, leaving behind the incorporated nucleotide. Multiple addition cycles of the four bases result in complementary strands typically greater than 25 bases in length synthesized on billions of templates—typically providing a greater than 25-base read from each of those individual templates.

The image processing pipeline takes the images that are captured by the camera in each cycle of the machine and determines the locations (i.e., x-y coordinates) of the incorporation of a base for that particular cycle. These locations are referred to as objects. This data is then outputted into a file for each one of the images. The image data is divided into batches. Each batch is referred to as a stack because all of the images in a batch come from different cycles at the same physical location on the flow cell. The objects from a given batch are plotted on an x and y axis which is essentially equivalent to stacking all of the images on top of each other. The objects are then correlated to determine which objects appear in the same location of different images to form a strand. This process, known as the strand formation algorithm, is how the actual DNA read is created.

The first element improves the throughput of the overall process by implementing an image segmentation procedure to identify sample objects. The second element also improves the throughput of the overall process by implementing an image registration procedure to align a plurality of images in a stack utilizing the segmented image data. The final element in the algorithm produces strands from the aligned sample objects in the stack of sample images.

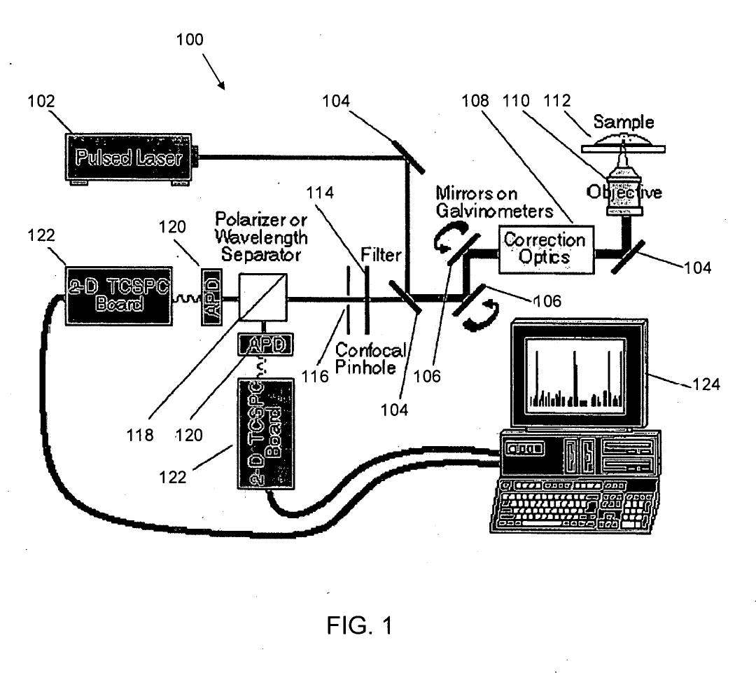

FIG. 1 is a representation of image analysis apparatus 100 in accordance with an embodiment of the invention. The apparatus 100 includes a pulsed laser 102 that produces a beam that is passed through a series of mirrors 104, mirrors coupled to galvanometers 106, correction optics 108, and an objective 110 to illuminate a sample 112 (e.g., the DNA strands attached to a surface). The laser beam is reflected by the sample and returns along its initial path and through a partially silvered mirror to a filter 114 and confocal pinhole 116. At this point, the reflected beam is separated into two beams based on polarization or wavelength by a separator 118. Each beam is then passed through dedicated avalanche photodiodes (“APDs”) 120 and image capture boards 122. Data from the image capture boards 122 are sent to a computer 124 for further processing by one or more software programs running on the computer 124. The program(s) perform the processing operations describe herein, and all or some portions of the program(s) can be stored in the computer 124 on its hard drive and/or in its permanent and/or temporary memory. All or some portions of the program(s) can be stored on any program storage medium that is readable by a computer such as, for example, one or more of RAM, ROM, removable memory/storage devices, hard drives, CDs, etc. The computer 124 is depicted in FIG. 1 as a desktop personal computer, but it can be any other type of computer and in fact any type of computing device now known or later developed (e.g., handheld, laptop, server, workstation, supercomputer, networked device, etc.) running any operating system as long as it is capable of performing the processing operations described herein.

Some image analysis techniques require a determination of whether an observed object is a single object or whether it is made up of several overlapping objects. When objects in an image are spaced closer together than the resolving power of the optics, several closely spaced objects can erroneously appear as one large object. Deblending is a process of attempting to determine whether an observed object is a single object or a collection of closely-spaced, but separate objects. The processing includes operations performed on the digital image data to effectively increase the resolution of the image and attempt to minimize or eliminate image artifacts. The deblending procedure involves computing several moments corresponding to the intensity data. The moments allow the characteristics (e.g., position and/or intensity) of the sample objects to be computed. The number of mathematical moments that are calculated depends upon the number of objects that one wishes to resolve. Methods and apparatus for analyzing images acquired during DNA sequencing using deblending have been described in U.S. patent application Ser. No. 11/345,730 to Tyurina, published Aug. 2, 2007 as US 2007/0177799 A1, the teachings of which are incorporated herein in their entirety. In general, resolution of closely-spaced objects using deblending procedures requires significant computer memory and processing time.

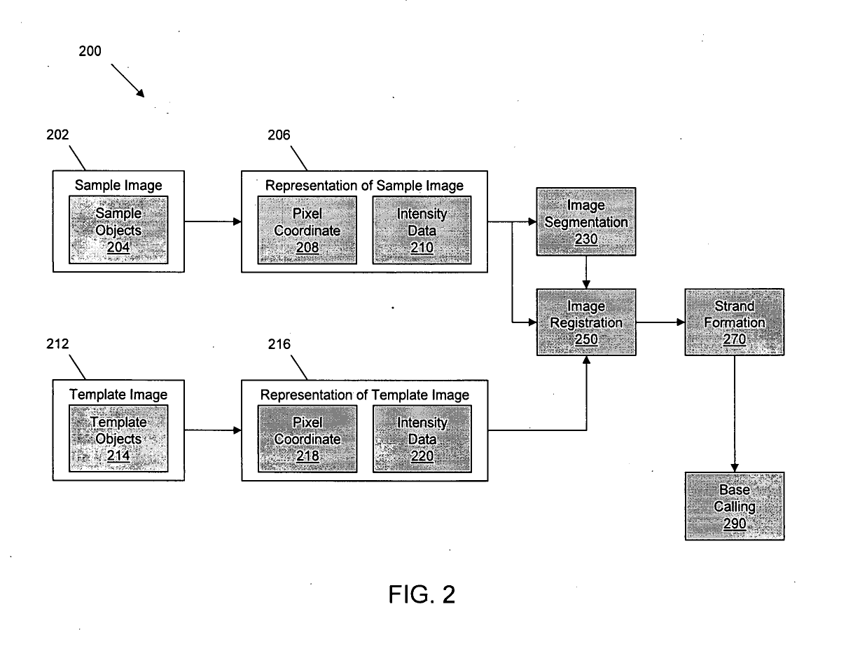

Described herein is a new strand formation algorithm that improves previous approaches both in terms of error-rate and in terms of throughput. The new algorithm is faster and has fewer errors than previous apparatuses. In a brief overview, FIG. 2 is a flowchart depicting a method 200 for image analysis in accordance with an embodiment of the invention. An image acquired after each incorporation step (i.e., a sample image 202) shows the location of each specific fluorescing nucleotide (i.e., sample objects 204). The sample image 202 is acquired using, for example, a personal computer with an image capture card. The image is recorded in one or more electronic files, typically in the “FITS” (Flexible Image Transport System) format. A photometry program then operates on the FITS files. One such program is Source Extractor, which is typically used in astronomical studies. The photometry program detects the locations and intensities and of the sample objects 204 and generates an 8 bit grayscale representation 206 of the sample image 202. The representation 206 includes a table or catalog containing intensity data 210 for each pixel coordinate 208 in the image. The intensity data 210 generally follows a Gaussian distribution.

Data from the sample images 202 are sent to a computer such as, for example, the desktop personal computer 124 depicted in FIG. 1 or any other type of computing device now known or later developed (e.g., handheld, laptop, server, workstation, supercomputer, networked device, etc.) running any operating system as long as it is capable of performing the processing operations described herein. The data from the sample images 202 undergo further processing by one or more software programs running on the computer 124. The program(s) perform the processing operations describe herein, and all or some portions of the program(s) can be stored in the computer 124 on its hard drive and/or in its permanent and/or temporary memory. All or some portions of the program(s) can be stored on any program storage medium that is readable by a computer such as, for example, one or more of RAM, ROM, removable memory/storage devices, hard drives, CDs, etc.

As stated above, DNA sequencing includes stacking the images from each incorporation cycle on top of each other and determining which objects appear in the same location of different images in the stack. The representation of the sample image 206 undergoes image segmentation 212 converting the 8 bit grayscale image into a black and white binary image. The binary images are then aligned with a template image 214 during image registration 224. The template image 214 can be any image but is usually the first image in the stack. The aligned stack of binary images proceed to the strand formation 226 phase where each of stacked sample objects 204 (i.e., candidate strands) are evaluated. The candidate strands that meet certain quality criteria are then further processed for base calling 228. At the end of this process 200 the sequence of the nucleotides in the template is known.

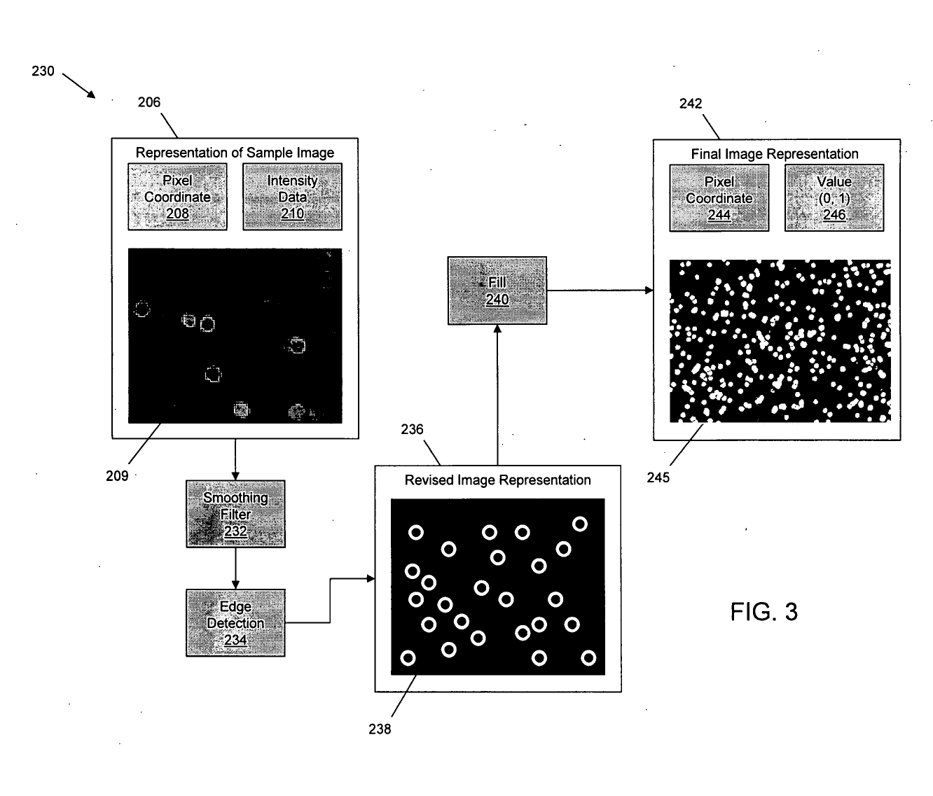

FIG. 3 is a flowchart depicting a method for performing image segmentation 230 in accordance with an embodiment of the invention. As described above, the representation of the sample image 206 includes pixel coordinates 208 and intensity data 210 of the fluorescing objects in an 8 bit grayscale format. The fluorescing objects generally appear in a constellation-like form 209. The process 230 generally includes a classical image segmentation method that converts the sample image into a simpler binary representation. In other words, the 8 bit gray levels are converted to a 1 bit level (i.e., black and white) where a 1 pixel value represents a pixel from the foreground region (white) and a 0 pixel value represents a pixel in the background region (black). The resulting binary image is called the foreground mask.

Several standard image segmentation methods exist including, for example, thresholding, edge detection, or region growing. In one exemplary embodiment, the sample image representation 206 is first smoothed with a 3×3 Gaussian smoothing filter 232 to reduce noise. One example of coefficients for the smoothing filter 232 are:

$$[ \begin{matrix}1 & 2 & 1 \\ 2 & 4 & 2 \\ 1 & 2 & 1\end{matrix} ]$$

The smoothed image is then processed with a Sobel edge detector 234 to determine the boundaries defining the perimeter of the sample objects 204. In images, the edges of objects are represented by areas with strong intensity contrasts, i.e., a jump in intensity from one pixel to the next adjacent pixel. Because the process of edge detection 234 in only concerned with the areas with strong intensity gradients and not the rest of the image, the amount of data associated with the image that requires further processing and to be stored is significantly reduced. Edge detection 234 also filters out useless information, while preserving the structural properties in the image that are important in DNA sequencing analysis.

There are many ways to perform edge detection 234. The Sobel operator performs a two dimensional spatial gradient measurement on an image to find the approximate absolute gradient magnitude at each point in the input grayscale image 209. The Sobel edge detector uses a pair of 3×3 convolution masks, one estimating the gradient in the x-direction and the other estimating the gradient in the y-direction. A convolution mask is usually much smaller than the actual image. As a result, the mask is slid over the image, manipulating a square of pixels at a time. At each image pixel location 208, the Sobel operator computes the gradient of the image intensities 210. If the gradient is greater than some threshold level, that pixel location 208 is identified as an edge and a value of 1 is retuned and if the gradient is less than the threshold level, that pixel location 208 is labeled with a 0 resulting in a revised image representation 236. The Sobel edge detector 234 can sometimes generate donut-looking objects 238 in the foreground mask therefore a final process step is to fill 240 in any holes in the foreground mask. The output of the image segmentation phase 230 is a final image representation 242 that includes a binary value 246 for each pixel location 244 known as a foreground mask 245.

The next step in the process is image registration 250. Image registration 250 refers to the process of aligning the plurality of foreground masks 245 in a stack such that the sample objects 204 associated with a DNA strand line up. During the sequencing operation, the camera (or optical equipment) is moved around to different physical locations on the flow cell and in some cases between multiple flow cells. It is difficult to move the camera around and then back to the exact same location due in part to mechanical limitations and limitations in the optical equipment itself. Therefore, a post sequencing correction, or image offset, is calculated to make up for the mechanical limitations

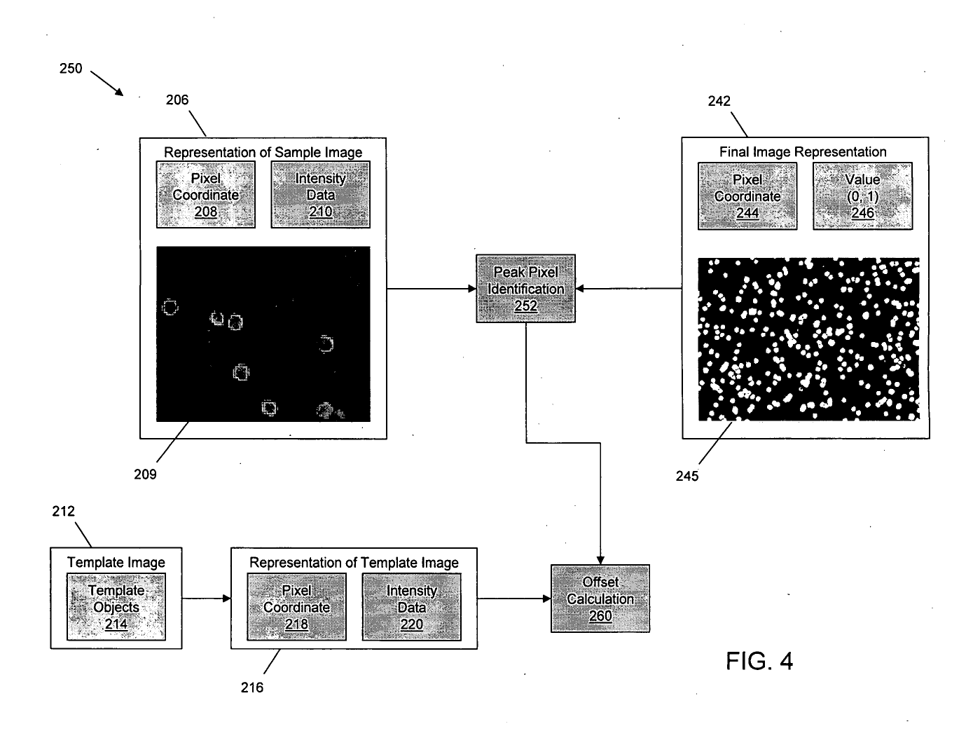

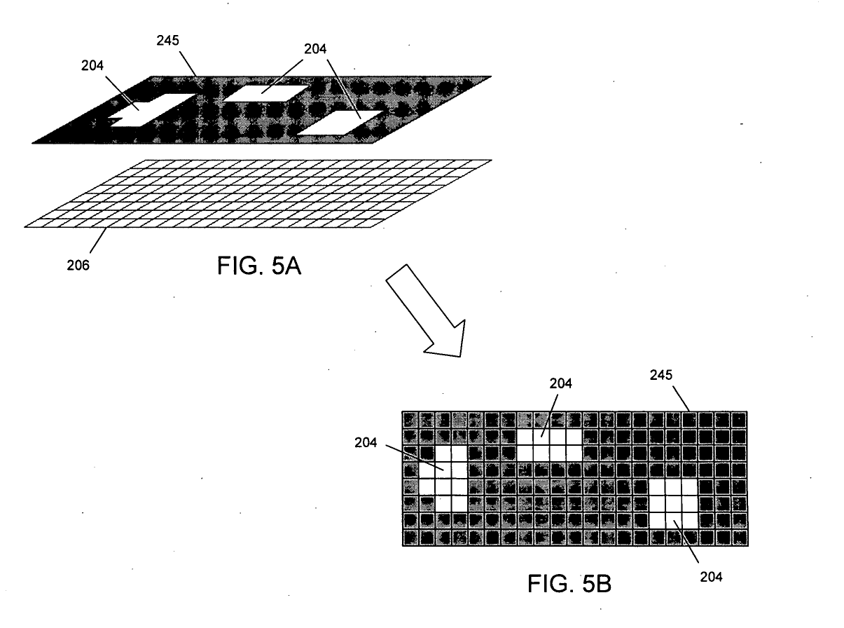

Referring now to FIG. 4, a flowchart depicting a method for performing image registration 250 in accordance with an embodiment of the invention is shown. During image registration 250, the foreground mask 245 from the image segmentation 230 phase is used in conjunction with the original sample image representation 206 to identify peak pixel locations 252. In essence, the foreground mask 245 is overlaid onto the sample image representation 206 as shown in FIGS. 5A and 5B. Only the regions identified in the foreground mask 245 as sample objects 204 are searched for peak pixels. Ignoring the regions not identified as sample object 204 regions in the image segmentation phase 230 reduces the data processing time requirements for image registration 250.

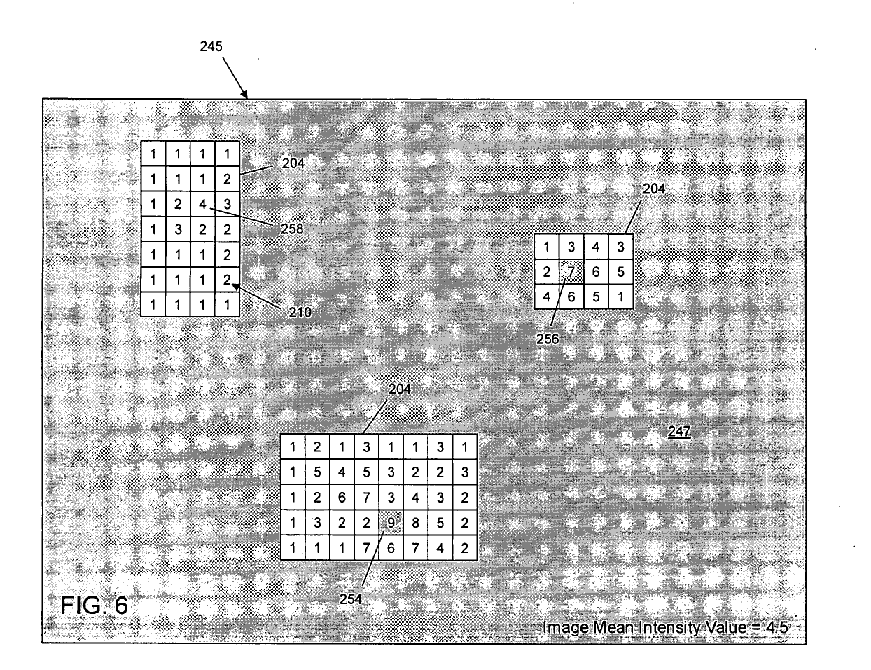

FIG. 6 is an illustration of a foreground mask 245 overlaid onto a sample image representation 206 with intensity data 210 in the form of numerals for each of the pixels associated with sample objects 204. The shaded area 247 represents the background, or black area, of the foreground mask 245. For the intensity data 210, the higher the number represents greater intensity. Peak pixel identification 252 includes determining which pixels have an intensity that is: (a) greater than the intensity of all eight neighboring pixels, and (b) greater than the mean intensity value of the entire sample image representation 206. The comparison to the image-wide mean intensity is done to eliminate “weak” peaks. For example, the two pixels 254 and 256 are shaded to indicate their identification as peak pixels. Each of the pixels 254, 256 have a higher value than the eight surrounding pixels and they are both greater than the image mean intensity of 4.5. Pixel 258 on the other hand is not identified as a peak pixel because its intensity value of 4 is less than the image mean intensity value of 4.5.

Referring now back to FIG. 4, the peak pixel locations are then used in the image offset calculation 260. The (x, y) coordinates of the peak pixels from each sample image 202 are compared to the (x, y) coordinates of peaks from a template image 212. The template image 212 could be any image from the stack, but for this implementation, the first image is used as the template 212. The peak pixel locations for the template image 212 are determined as described above with respect to the sample image 202. Then, the (Δx, Δy) offset is computed from each peak pixel in the sample image 202 to peaks in the template image 212 within a predetermined distance known as the allowable registration shift. The process is repeated for every peak pixel in the sample image 202.

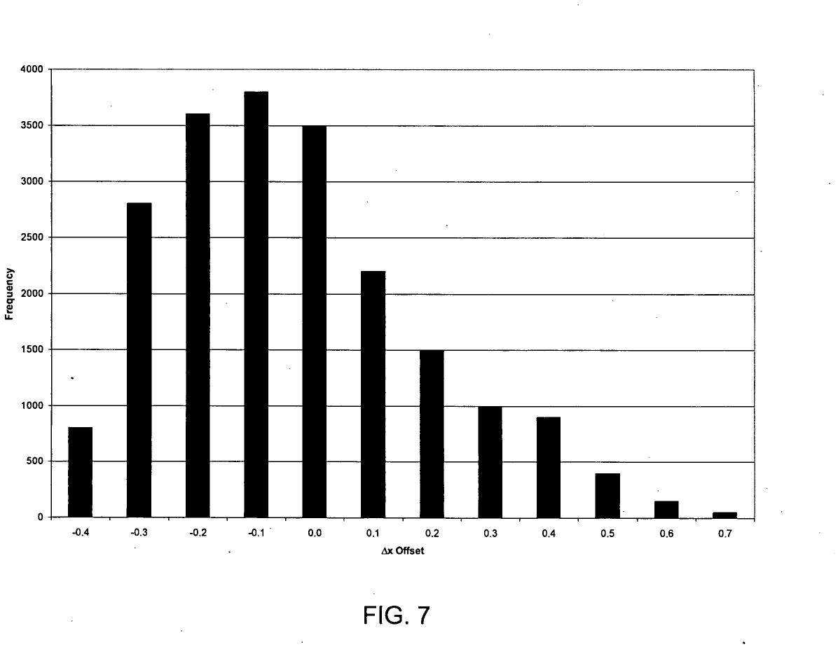

The offset data for all of the peak pixels in the sample image 202 is compiled and analyzed to determine the best (Δx, Δy) transformation for the entire sample image 202. One method of analyzing the offset data is to add each computed peak offset to a two-dimensional histogram. The Δx and Δy values that occur most frequently (i.e., the highest bar on the histogram) represents the best (Δx, Δy) transformation (i.e., offset) for that sample image 202. FIG. 7 depicts an example of a Δx offset histogram for one sample image 202 showing a Δx offset of −0.1 occurring most frequently.

To reduce overall computational complexity during the offset calculation 260 stage, the sample image 202 can be tiled into rectangular sub-regions. By tiling, the (Δx, Δy) offset for each pixel in the sample image 202 is only calculated for the peak pixels falling in a particular tile in the template image 212. The tile size can be selected in using any of a variety of metrics included, for example, allowable registration shift. The reduced computation complexity associated with tiling of the template image 212 translated into reduced processing time.

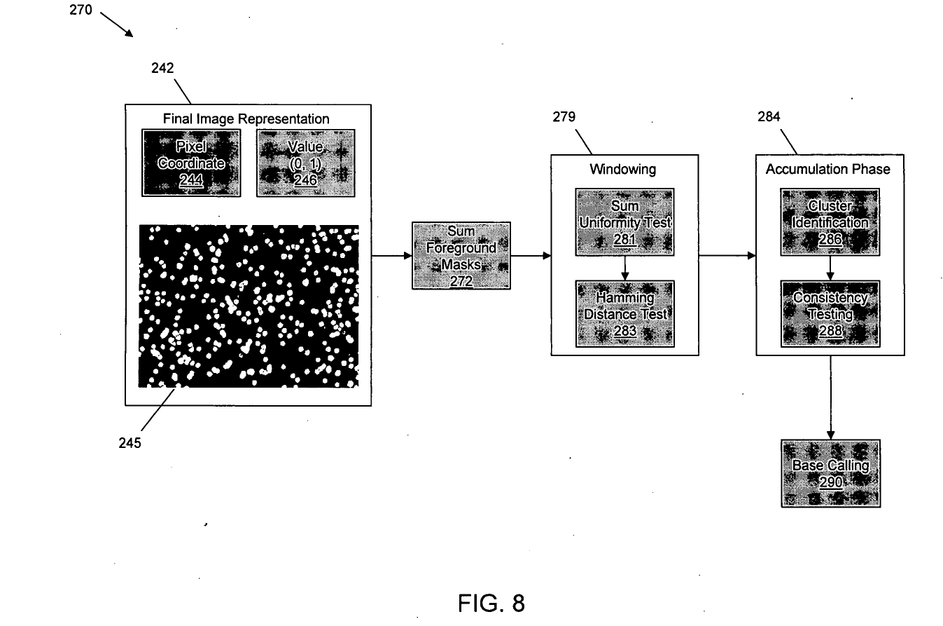

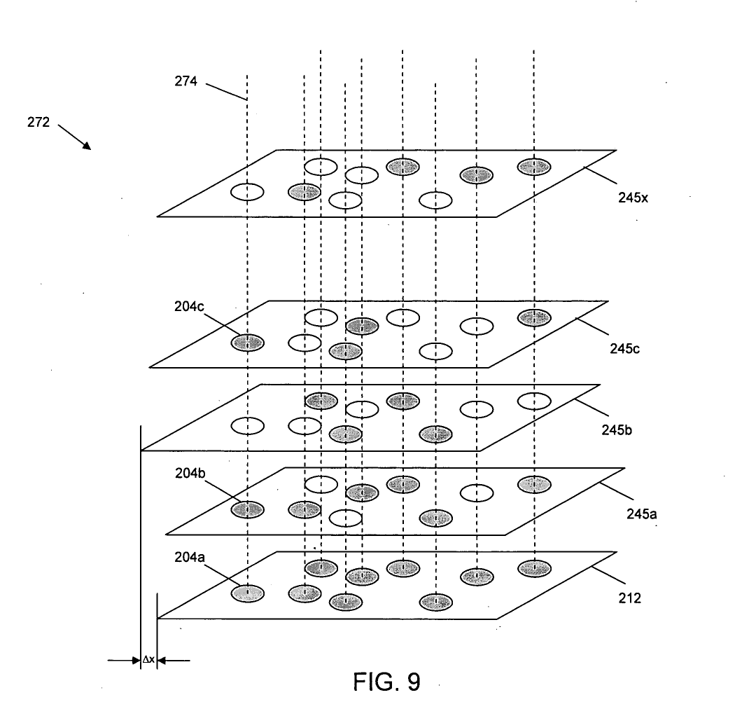

After the image segmentation 230 and image registration 250 phases are completed, the output data file is a binary image plus a (Δx, Δy) offset for each incorporation cycle. The next step in the image analysis method 200 is to use the data files for each incorporation cycle to produce DNA strands (reads). FIG. 8 is a flowchart depicting a strand formation method 270 in accordance with an embodiment of the invention. The first step of the strand formation 270 phase is to generate a master image by summing 272 all of the foreground masks 245. As shown in FIG. 9, the foreground masks 245a, 245b, 245c, etc. (collectively 245) of each sample image are stacked on top of each other taking into account their offset (Δx). The (Δy) offset is also taken into account, but is not shown in FIG. 9. Each of the foreground masks 245 represent one incorporation cycle (i.e., base incorporation followed by wash step). The Δx offset allows the sample objects 204a, 204b, and 204c (collectively 204) from the different sample images 245 to line up along an axis 274.

Sample object 204b corresponds to one of the nucleotides (A, G, C, &T/Us) and, because its location correlates (within a reasonable range of uncertainty) with the location of the sample object 204a on the template image 212, it can be concluded that an incorporation event occurred. In other words, at this point on the DNA strand, a specific nucleotide is present. A second incorporation cycle is represented by foreground mask 245b. During this incorporation cycle, four sample objects are present represented by the shaded region, but the region corresponding to object 204a on the template image 216 along axis 274 is not shaded which means no incorporation event occurred at that location. The process repeats with a third incorporation cycle represented by foreground mask 245c. The next location 204c along the DNA strands (axis 274) is shaded indicating that an incorporation event occurred. This process continues until the last location in the DNA strands is subjected to the sequential washes and the locations of the fluorescing objects are compared. At this point the user has compiled a list of candidate strands.

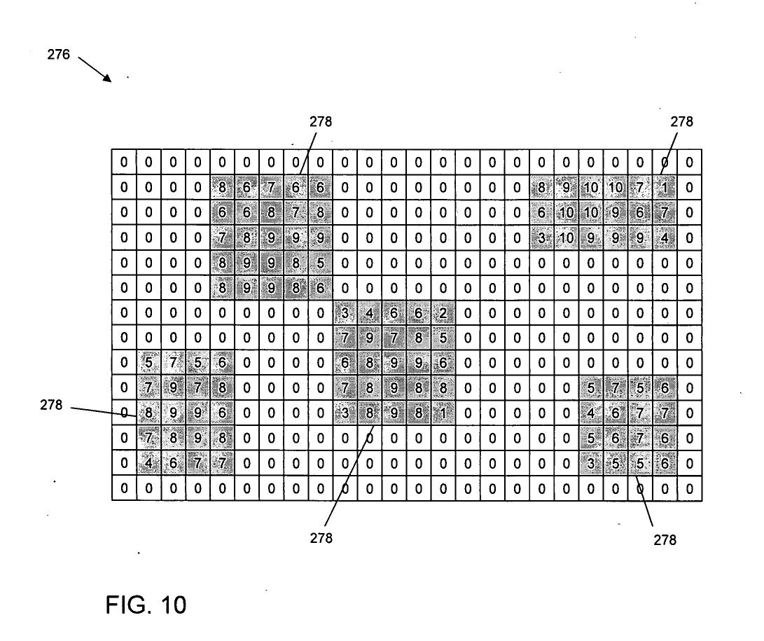

Referring now to FIG. 10, the summed foreground masks 245 create a master image 276 with an integer value between 0 and X for each individual pixel in the image 276 where X is the total number of incorporation cycles. Because the foreground masks 245 ignore the background, the master image 276 also ignores the background (i.e., pixel with a 0). When the sample objects 204a, 204b, and 204c (FIG. 9) from the foreground masks 245 are stacked up and aligned to create the master image 276, the stack of sample objects form a candidate strand 278 that includes a plurality of pixels. The candidate strands 278 are then evaluated in a windowing phase 279 to determine if they meet certain quality conditions before they are considered actual strands for base calling.

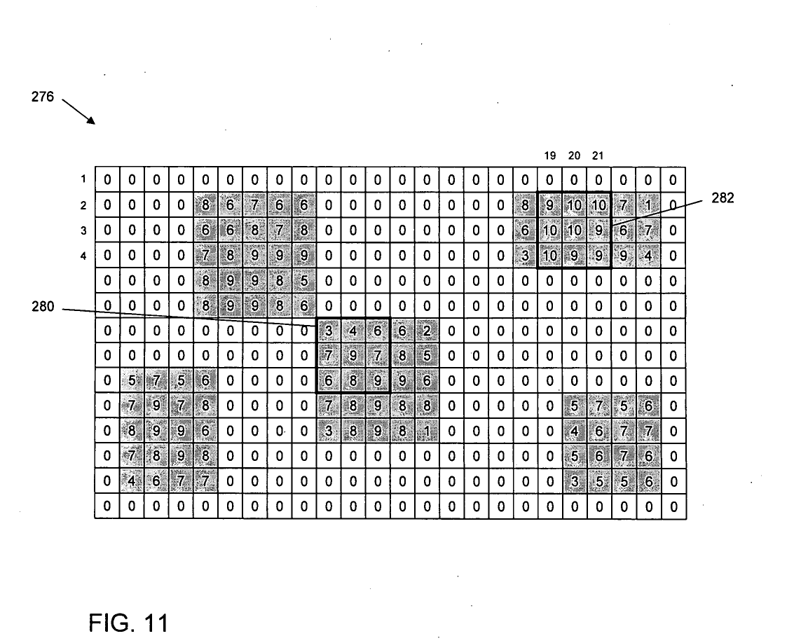

The first step in the windowing phase 279 involves analyzing small regions (e.g., 3×3 pixels) of the master image 276 for uniformity in their sum. In the sum uniformity test 281, the center pixel of the small region is considered a hypothetical centroid. The sum at the hypothetical centroid is compared with the sum of each of the neighboring pixels in the small region and if the sums are within some allowable tolerance (e.g., 10%), the small region is further subjected to a Hamming distance test. For example, as shown on FIG. 11, the center pixel in small region 280 has a value of 9 and the pixel directly above it has a value of 4. Small region 280 would be ignored because the difference is well above the acceptable tolerance of 10%. However, the center pixel in small region 282 has a value of 10 and all of the other pixels in the small region have values within 1 (i.e., 10% difference), therefore small region 282 would then be further subjected to a Hamming distance test.

The Hamming distance test 283 is used to measure the similarity between two bit strings of equal length. Hamming distance is the number of positions for which the corresponding bit values in the two stings are different. In other words, the test measures the minimum number of substitutions that would be necessary to change one bit string into the other.

In the Hamming distance test 283, bit-strands are extracted from the master image 276 at each pixel location in a small region that satisfies the sum uniformity test 281. Bit-strands are comprised of an (x, y) coordinate and either a 1 or a 0 (i.e., 1 bit) for each foreground mask 245 in the stack. For example, the bit-strands for the second row of small region 282 are shown in the table below.

| Pixel Coordinate | Bits |
|---|---|
| 19, 3 | 101010100010001001001011 |
| 20, 3 | 101010100010001001001011 |
| 21, 3 | 100010100010001001001011 |

To perform the Hamming distance test 283 on small region 282, the Hamming distance is calculated between the hypothetical centroid (20, 3) and each of the neighboring pixels in the small region 282. For example, the Hamming distance between the bit-strand (20, 3) and the bit-strand immediately to the left, i.e., coordinate (19, 3), is the number of substitutions that would be necessary to change one bit-strand into the other. In this case, the Hamming distance is zero because the two strands are identical. However the Hamming distance between the centroid (20, 3) and coordinate (21, 3) is one because the 1 in the third position of the centroid (20, 3) would have to be changed to a 0 to match the bit-strand at coordinate (21, 3). This process continues until the pair-wise hamming distance is calculated between the centroid and each of the neighboring pixels in the small region.

If the Hamming distance between the centroid and particular pixels in that small region is within some allowable tolerance (e.g., 10%), those pixels are associated with each other as a cohort. Therefore, up to nine pixels (including the centroid) can be associated with a cohort. The small region is then incremented across the entire master image 276. Each pixel can potentially be associated with nine different cohorts, once as the center pixel and eight times as a neighboring pixel. The number of times a pixel participates in a cohort is tracked and used as a ranking for the accumulation phase 284 of the algorithm. This windowing 279 process essentially is a way of ranking candidate strand centroids.

During the accumulation phase 284 of the algorithm, the ranked list of candidate strand centroids is traversed in descending order. The pixels with nine cohort associations are processed first, followed by those with eight cohort associations, and then seven, etc. Every pixel directly associated with the candidate strand centroid (i.e., its neighboring pixels) are “claimed” by that centroid forming a cluster 286. Any pixels directly associated with those neighboring pixels are claimed by the candidate strand centroid as well. The process continues allowing centroids to claim pixels within a maximum radius of the centroid (e.g., 2 pixels). Any pixel already claimed in a previous step is disallowed for inclusion in any subsequent cluster. The accumulation phase 284 ends when no more pixels remain to be claimed, or the largest possible remaining potential cluster is smaller than some minimum threshold (e.g. 4 pixels), whichever condition occurs first.

The clusters identified 286 in the accumulation phase 284 are potential strand of DNA. There are generally about 4 to 9 pixels in each cluster and each pixel has bit-strand data associated with it. The number of pixels in a cluster serves as an indication of overall strand quality, but before actual bases can be called, the bit-strands in the cluster are tested for consistency 288.

First, each bit-strand in a cluster is tested for consistency 288 with respect to the rest of the bit-strands in the cluster. This operation is similar to the Hamming distance test described above, however in this test, the consistency among all of the bit-strands are checked instead of only pair-wise testing. There are many ways of testing the consistency of the cluster. One example of a consistency test 288 is to determine how well the bits in a particular stand match up with the bits of the other strands in the cluster. If at least 75% of the bits in a strand, match up with at least 75% of the other strands in the cluster, then the strand is included in the cluster. For example, if a cluster has 8 pixels and the bit-strands associated with each pixel are 20 bits in length, at least 15 (i.e., ¾ of 20) of the bits must have a score of 6 (i.e., ¾ of 8) or better in order for a bit-strand to pass the consistency test 288. The score is determined simply by adding up the number of bits in agreement at each position in the bit-strand. If both of these criteria are met, the strand is included in the cluster for base calling. Otherwise the strand is eliminated from the cluster.

Next, the clusters are processed for base calling 290. First, the bits are summed at each position of the bit-strands as shown in the table below. These per-bit scores serve as an estimate of relative base quality, however, bases can be excluded if they do not meet a minimum threshold criteria. For example, if a base does not appear in greater than 25% of the bit-strands, that base is not called. As shown in the table below, only one base appeared in the third position (i.e., not greater than 25% of the bit strands) so no base was called. Thus, in this example, the final DNA strand sequence is CCATAATC.

| | |
|---|---|
| Pixel Coordinate | Bits |

| | |
|---|---|
| Base | CTAGCTAGCTAGCTAGCTAGCT |
| 10, 10 | 1000001001100010010000 |
| 10, 11 | 1000101000100010010010 |
| 11, 10 | 1010101000100010010010 |
| 11, 11 | 1000101001100010000010 |
| Per-bit scores | 4010304002400040030030 |
| Called sequence | C C A TA A T C |

Referring now back to FIGS. 1 and 2, apparatus 100 performs a method 200 for optical detection and image analysis for single molecule sequencing technologies in accordance with an embodiment of the invention. As described above, the apparatus 100 includes an image capture subsystem that acquires images of fluorescing objects (i.e., template objects 214, or sample objects 214, or both), digitizes them, and generates corresponding image data that can be stored on any storage medium that is readable by a computer such as, for example, one or more of RAM, ROM, removable memory/storage devices, hard drives, CDs, etc. Data from the image capture subsystem are sent to a computer 124 for further processing by one or more software programs running on the computer 124. The program(s) perform the processing operations describe herein, and all or some portions of the program(s) can be stored in the computer 124 on its hard drive and/or in its permanent and/or temporary memory. All or some portions of the program(s) can be stored on any program storage medium that is readable by a computer. The computer 124 is depicted in FIG. 1 as a desktop personal computer, but it can be any other type of computer and in fact any type of computing device now known or later developed (e.g., handheld, laptop, server, workstation, supercomputer, networked device, etc.) running any operating system as long as it is capable of performing the processing operations described herein.

First software code processes the optical data 202 and generates a representation of the sample image 206 that includes intensity data 210 for each pixel coordinate 208 in the image 206. In the context of DNA sequencing, at least some of the pixel coordinates 208 are associated with a single molecule of one of the nucleic acid sequences (i.e., DNA strands) adhered to a surface.

Second software code processes the sample image 202, or the representation of the sample image 206, or both, computes gradients of the intensity data 210 corresponding to the pixel coordinates 208, and generates a final image representation 242 that includes a binary value 246 for each pixel location 244 as a foreground mask 245. The apparatus 100 can repeat this process any number of times for a plurality of sample images 202.

The apparatus 100 includes third software code for processing the representation of the sample image 206 and the foreground mask 245 to determine peak pixel locations 252 and aligning a plurality of foreground masks 245 in a stack. The third software code generally does this by comparing the peak pixel locations 252 in the plurality of sample images 206 to a template image 212. The output of the third software code includes an offset (Δx, Δy) for each of the plurality of foreground masks 245.

The apparatus 100 includes fourth software code for processing the aligned stack of foreground masks 245 to identify candidate strand locations 278, which are then evaluated to identify nucleotide incorporations. The forth software code generally does this by evaluating the candidate strands 278 for uniformity and consistency between individual bit-strands. Candidate strands 278 that meet certain quality and consistency criteria are considered actual strands and are processed for base calling 290.

The disclosed embodiments are exemplary. The invention is not limited by or only to the disclosed exemplary embodiments. Also, various changes to and combinations of the disclosed exemplary embodiments are possible and within this disclosure.

What is claimed is:

1. An image analysis method for identifying nucleotide incorporations, comprising:
(a) performing an image segmentation procedure on each of a plurality of data sets to identify for each of the data sets a plurality of sample objects and to create a plurality of segmented data sets which each represents the identified sample objects for one of the data sets, each of the data sets representing a sample image, each sample image including a plurality of pixel locations and intensity data associated with each of the pixel locations;
(b) performing an image registration procedure on the segmented data sets created in step (a) to align the identified sample objects and to create data representative of the aligned identified sample objects; and
(c) performing a strand formation procedure on the data created in step (b) to identify nucleotide incorporations.

2. The image analysis method of claim 1 wherein the image segmentation procedure comprises generating a foreground mask for each of a plurality of data sets.

3. The image analysis method of claim 1 wherein the image segmentation procedure comprises using a Sobel operator to identify an edge for each of the plurality of sample objects.

4. The image analysis method of claim 1 wherein the image segmentation procedure comprises performing a smoothing function on the data.

5. The image analysis method of claim 1 wherein the image registration procedure comprises comparing the intensity data associated with each pixel location with the intensity data associated with adjacent pixel locations.

6. The image analysis method of claim 1 wherein the image registration procedure comprises comparing the intensity data associated with each pixel location with an image mean intensity value.

7. The image analysis method of claim 1 wherein the image registration procedure comprises:
comparing the intensity data associated with each pixel location with the intensity data associated with adjacent pixel locations;
comparing the intensity data associated with each pixel location with an image mean intensity value; and
generating a data set representing sample peak pixel locations.

8. The image analysis method of claim 7 further comprising:
comparing the data set representing sample peak pixel locations to a data set representing template peak pixel; and
determining an image data offset for the data representing each of the plurality of sample images.

9. The image analysis method of claim 1 wherein the strand formation procedure comprises identifying candidate strand locations.

10. The image analysis method of claim 1 wherein the strand formation procedure comprises analyzing data associated with the aligned identified sample objects to identify candidate strand locations.

11. The image analysis method of claim 1 wherein the strand formation procedure comprises:
analyzing data associated with the aligned identified sample objects to identify candidate strand locations; and
extracting the nucleotide incorporation data for each candidate strand location.

12. An image analysis method comprising:
(a) performing an image segmentation procedure on each of a plurality of data sets to identify for each of the data sets a plurality of sample objects and to create a plurality of segmented data sets which each represents the identified sample objects for one of the data sets, each of the data sets representing a sample image, each sample image including a plurality of pixel locations and intensity data associated with each of the pixel locations;
(b) performing an image registration procedure on the segmented data sets created in step (a) to align the identified sample objects and to create data representative of the aligned identified sample objects, the image registration procedure comprising identifying sample peak pixel locations; and
(c) performing a strand formation procedure on the data created in step (b) to identify nucleotide incorporations, the strand formation procedure comprising:
analyzing the data created in step (b) to identify candidate strand locations; and
extracting the nucleotide incorporation data for each candidate strand location.

13. The image analysis method of claim 12 wherein the image segmentation procedure comprises using a Sobel operator to identify an edge for each of the plurality of sample objects.

14. The image analysis method of claim 12 wherein the image segmentation procedure comprises performing a smoothing function on the data.

15. The image analysis method of claim 12 wherein identifying sample peak pixel locations comprises:
comparing the intensity data associated with each pixel location with the intensity data associated with adjacent pixel locations;
comparing the intensity data associated with each pixel location with an image mean intensity value; and
generating a data set representing sample peak pixel locations.

16. The image analysis method of claim 15 further comprising:
comparing the data set representing sample peak pixel locations to a data set representing template peak pixel; and
determining an image data offset for the data representing each of the plurality of sample images.

17. An image processing apparatus for use in a single-molecule detection system, the image processing apparatus comprising:
an image capture subsystem for receiving optical information from a plurality of nucleic acid sequences adhered to a surface and for generating a first set of data representative of the optical information;
a first software code for processing the first set of data to create a second set of data representative of a two-dimensional field pattern that includes a plurality of pixels and intensity data associated with each of the plurality of pixels;
a second software code for processing at least one of the first or second sets of data creating a third set of data representative of a replacement two-dimensional field pattern that includes a plurality of objects, each of at least some of the objects being associated with a single molecule of one of the nucleic acid sequences;
a third software code for processing the third set of data to determine peak pixel locations and aligning a plurality of replacement two-dimensional fields in a stack, the third software code creating a forth set of data representative of the aligned stack of the replacement two-dimensional fields, each of at least some of the aligned stacks being associated with a single molecule of one of the nucleic acid sequences; and
a forth software code for processing the aligned stacks to identify candidate strand locations and evaluating the candidate strand locations to identify nucleotide incorporations.

18. The apparatus of claim 17 wherein the second software code calculates several gradients of the intensity data associated with the plurality of pixels.

19. The apparatus of claim 17 wherein the third software code compares the third set of data with template data to align the plurality of replacement two-dimensional fields in a stack.


SEQUENCE LISTING (1 sequence)

SEQ ID NO: 1 - DNA, 22 bp, Artificial Sequence
  Exemplary DNA sequence for base calling program
ctagctagctagctagctagct